(19) United States
(12) Patent Application Publication
(10) Pub. No.: US 2008/0117316 A1
(43) Pub. Date: May 22, 2008

(54) MULTI-EYE IMAGE PICKUP DEVICE

(75) Inventor: Masaaki ORIMOTO, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/944,256

(22) Filed: Nov. 21, 2007

(30) Foreign Application Priority Data
Nov. 22, 2006 (JP) 2006-315938

(51) Int. Cl. H04N 5/262; H04N 5/225; H04N 5/228

(52) U.S. Cl. 348/240.3; 348/262; 348/222.1; 348/E05.024; 348/E05.031; 348/E05.051

(57) ABSTRACT

A multi-eye camera includes imaging units which are detachably attached to a camera main body. The camera main body has a concave container portion to which at most four imaging units in either vertical or horizontal orientation can be attached at the same time. A length between the optical axes of two imaging units is denoted by a base length R. Attachment positions and orientations of the imaging units can be changed according to a distance from the multi-eye camera to a subject for being captured, so that the length of the base length R is optimized for the subject.

### BACKGROUND OF THE INVENTION

1. Field of the Invention

The present invention relates to an image pickup device which obtains a subject image by photoelectric conversion of subject light, and especially relates to a multi-eye image pickup device which obtains at least two images with parallax for making a stereo image or the like.

2. Description of the Related Arts

A multi-eye camera in which two imaging optical systems are arranged in the horizontal direction to capture two images with parallax is known. From the two parallax images captured by the multi-eye camera, information of the depth direction of the image, that is, stereo information of the photographed subject (hereinafter, three-dimensional data) can be obtained. The three-dimensional data includes precise information, such as irregularity of the subject surface as well as its color and shape, and is often used for image recognition or such purpose. For example, when the multi-eye camera is used as a surveillance camera, a person can be recognized with high accuracy based on three-dimensional data of the person's face.

Since the multi-eye camera has the plural imaging optical systems in a single camera main body, a size of the camera main body becomes large and there becomes a portability problem. In consideration of this problem, U.S. Pat. No. 7,102,686 discloses a multi-eye camera composed of a single-eye camera and a plurality of imaging units detachably attached to the single-eye camera. Accordingly, this camera has no portability problem when used as the single-eye camera.

Recently, a display method and device for displaying a stereo image based on two parallax images are known. This type of display device displays the stereo image based on two horizontally long images with parallax in the horizontal direction. A conventional multi-eye camera, having two imaging optical systems arranged in the horizontal direction to perform so-called horizontal imaging, cannot perform so-called vertical imaging (at this time the long side of the camera is in the vertical direction). In consideration of this problem, Japanese Patent Laid-Open Publication No. 10-224820 discloses a multi-eye camera in which an image pickup element is rotated when the vertical imaging, so that two images with parallax in the vertical direction of the images can be obtained through the vertical imaging.

However, when the imaging unit is detachably attached to the single-eye camera, a distance between the optical axes of the imaging units (hereinafter, a base length) is determined by a size of the attached imaging unit. Accordingly, it is difficult to appropriately adjust the base length according to a distance to a subject, especially it is difficult to shorten the base length to obtain three-dimensional data of close view.

In addition, in the multi-eye camera of Japanese Patent Laid-Open Publication No. 10-224820, the rotational center of the image pickup element is fixed. Accordingly, it is difficult to select or change the base length in this multi-eye camera.

### SUMMARY OF THE INVENTION

An object of the present invention is to provide a multi-eye image pickup device which can select an appropriate base length according to a distance to a subject being captured.

In order to achieve the above and other objects, a multi-eye image pickup device of the present invention comprises a plurality of imaging units and a camera main body. Each imaging unit has an imaging optical system and an image pickup element. To the camera main body, the imaging units are detachably attached with their attachment positions and orientations being selectable.

It is preferable that the imaging optical system is a bending optical system which bends light from the subject toward the image pickup element.

It is preferable that the imaging unit has a rectangular parallelepiped shape. More preferably, an objective lens of the imaging optical system is positioned on a front face of the imaging unit, such that the center of the objective lens and the center of the front face are not coincident. Especially, the front face has a rectangular shape whose long side is twice as long as whose short side, and the objective lens is positioned near to one of four corners of the front face.

It is preferable that the plurality of imaging units includes a first imaging unit and a second imaging unit, and objective lenses of the first and second imaging units are symmetrically-positioned about contacting side faces of the first and second imaging units, when the first and second imaging units are arranged such that the side faces are in contact and the front faces are on a same line.

It is preferable that the camera main body includes a concave container portion and a unit controller. In the concave container portion, each of the imaging units can be contained in horizontal or vertical orientation. The unit controller connects the imaging unit contained in the concave container portion to obtain image data from the imaging unit.

It is preferable that the concave container portion has an attachment face of rectangular shape, and each of short and long sides of the attachment face is natural-number times as long as each side of the imaging unit.

It is preferable that the imaging unit has a first connector on a face opposite to a face where an objective lens of the imaging optical system is positioned, and that the camera main body has a plurality of second connectors on the attachment face. One of the second connectors is faced and connected to the first connector according to an attachment position and an orientation of the imaging unit, and the unit controller detects the attachment position and the orientation of the imaging unit according to connection state between the first and second connectors.

According to the multi-eye image pickup device of the present invention, attachment positions and orientation of the imaging units can be changed according to a distance to a subject being captured, so that the length of the base length is optimized for the subject.

### BRIEF DESCRIPTION OF THE DRAWINGS

The above and other subjects and advantages of the present invention will become apparent from the following detailed description of the preferred embodiments when read in association with the accompanying drawings, which are given by way of illustration only and thus are not limiting the present invention. In the drawings, like reference numerals designate like or corresponding parts throughout the several views, and wherein:

FIG. 1 is a perspective view of a multi-eye camera of the present invention;

FIG. 2 is a perspective view of an imaging unit of the multi-eye camera;

FIG. 3 is a vertical cross sectional view of the imaging unit showing an optical construction, the cross section being parallel to a front face of the imaging unit;

FIG. 4 is a vertical cross sectional view of the imaging unit showing the optical construction, the cross section being perpendicular to the front face of the imaging unit;

FIG. 5 is a perspective view of a front face of a camera main body;

FIG. 6 is a perspective view of a rear face of the camera main body;

FIG. 7 is a block diagram showing an electronic configuration of the multi-eye camera;

FIG. 8 is a perspective view showing the multi-eye camera in which two imaging units of the same type are arranged such that a base length becomes R2;

FIG. 9 is a perspective view showing the multi-eye camera in which the two imaging units of the same type are arranged such that the base length becomes R5;

FIG. 10 is a perspective view showing the multi-eye camera in which the two imaging units of the same type are arranged such that the base length becomes R8;

FIG. 11 is a perspective view showing the multi-eye camera in which two imaging units of different types are arranged such that the base length becomes R1;

FIG. 12 is a perspective view showing the multi-eye camera in which the two imaging units of different types are arranged such that the base length becomes R3;

FIG. 13 is a perspective view showing the multi-eye camera in which the two imaging units of different types are arranged such that the base length becomes R4;

FIG. 14 is a perspective view showing the multi-eye camera in which the two imaging units of different types are arranged such that the base length becomes R6;

FIG. 15 is a perspective view showing the multi-eye camera in which the two imaging units of different types are arranged such that the base length becomes R7;

FIG. 16 is a perspective view showing the multi-eye camera in which the two imaging units of different types are arranged such that the base length becomes R9;

FIG. 17 is a perspective view showing the multi-eye camera in which the two imaging units in the horizontal orientation are arranged such that the base length becomes R10;

FIG. 18 is a perspective view showing the multi-eye camera in which the two imaging units in the horizontal orientation are arranged such that the base length becomes R11;

FIG. 19 is a perspective view showing the multi-eye camera in which four imaging units in the horizontal orientation are arranged for image capturing of a distant subject;

FIG. 20 is a perspective view showing the multi-eye camera in which the four imaging units in the horizontal orientation are arranged for image capturing of a close subject;

FIG. 21 is a perspective view showing the multi-eye camera in which the four imaging units in the horizontal orientation are arranged for image capturing both a distant subject and a close subject;

FIG. 22 is a perspective view showing the multi-eye camera in which two imaging units in the vertical orientation and two imaging units in the horizontal orientation are arranged for image capturing of a distant subject; and

FIG. 23 is a perspective view showing the multi-eye camera in which the two imaging units in the vertical orientation and the two imaging units in the horizontal orientation are arranged for image capturing of a close subject.

### DETAILED DESCRIPTION OF THE PREFERRED EMBODIMENTS

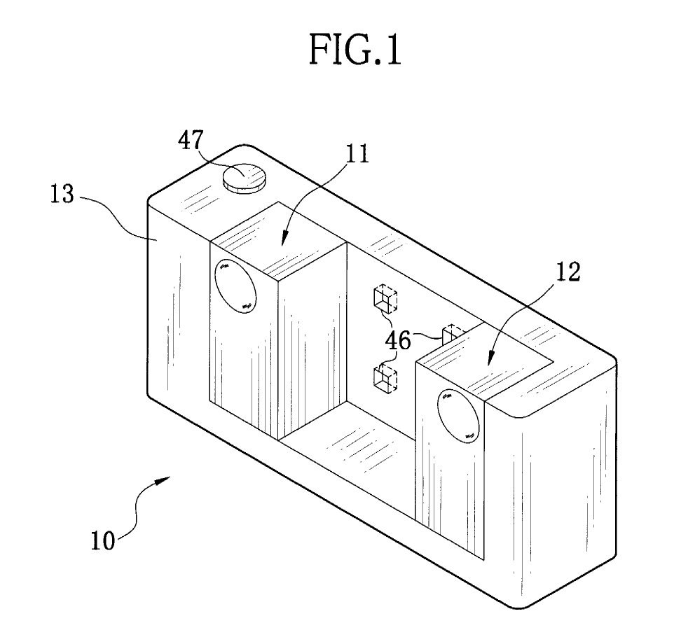

As shown in FIG. 1, a multi-eye camera 10 (multi-eye image pickup device) of the present invention comprises an imaging unit 11 (the first imaging unit) and an imaging unit 12 (the second imaging unit) each of which obtains an image signal by photoelectrically converting subject light, and a camera main body 13 to which the plural imaging units can be concurrently attached.

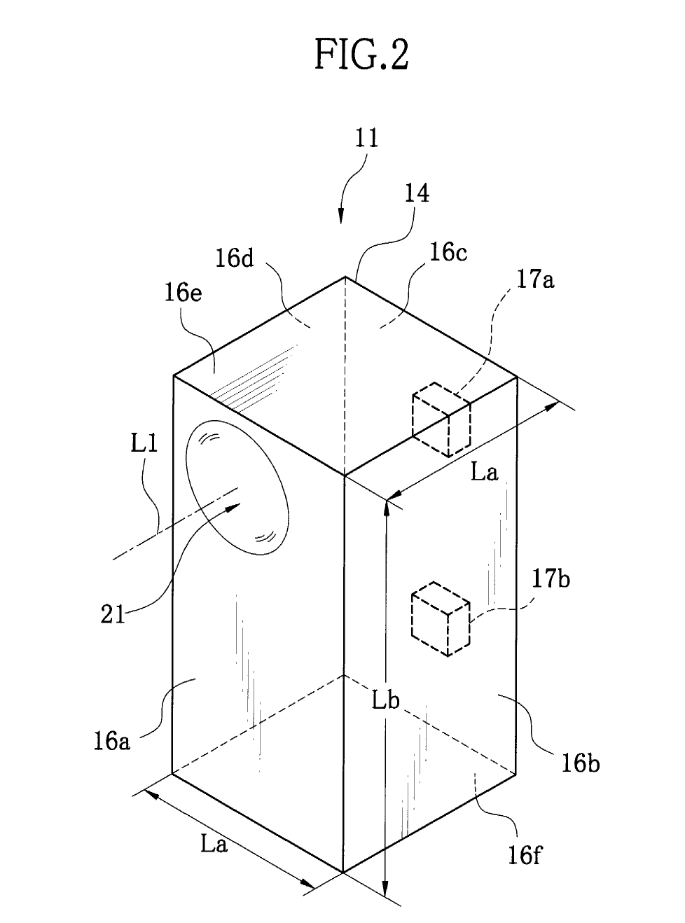

As shown in FIG. 2, a case 14 of the imaging unit 11 is formed into a rectangular parallelepiped shape, the shape of two cubes joined vertically. Accordingly, a front face 16a, a right side face 16b, a rear face 16c and a left side face 16d of the case 14 have a rectangular shape whose long side Lb is twice as long as the short side La. An upper face 16e and a bottom face 16f of the case 14 have a square shape each side of which is the short side La.

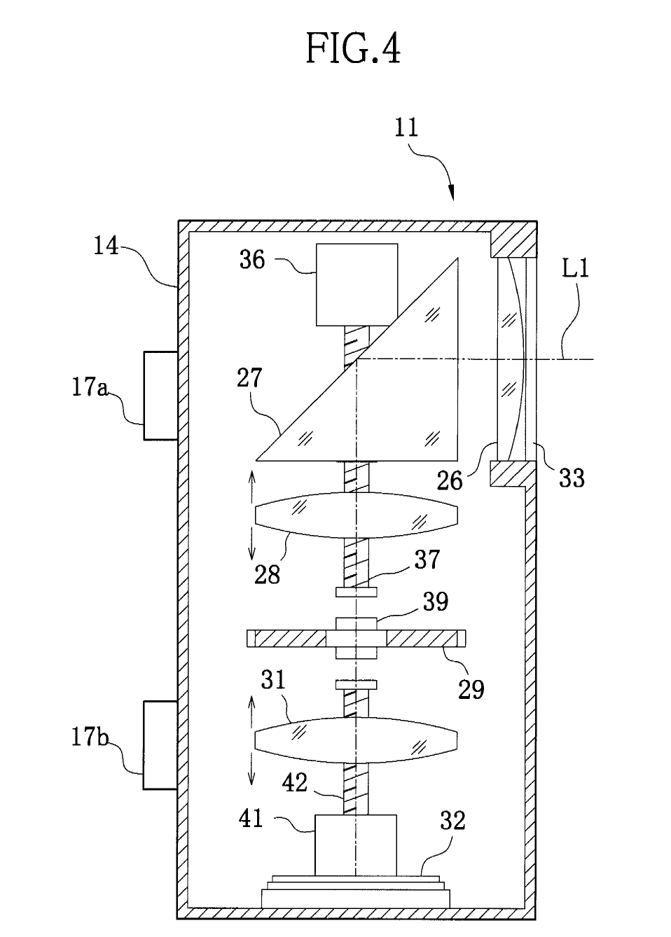

On the front face 16a, an objective lens 26 (see FIG. 4) of an imaging optical system 21 is arranged near to an upper left corner. The center of the lens 26 and the center of the front face 16a are not coincident. On the rear face 16c, convex connectors 17a and 17b (the first connectors) having a square face are formed at positions of La/2 and 3La/2 on the vertical center line from the upper edge. On an upper surface of each of the convex connectors 17a and 17b, a connecting terminal and a detecting terminal are formed. The connecting terminal is for signals of image data and various commands. The detecting terminal is for confirmation signals of orientation of the imaging unit (vertical or horizontal orientation), an attached position of the imaging unit to the camera main body 13, and a type of the imaging unit (for example, the imaging unit 11 or the imaging unit 12) classified according to the position of the optical axis. For example, the detecting terminal is arranged on one side of the connecting terminal.

The convex connectors 17a and 17b are fitted into concave connectors 46 (described later) of the camera main body 13, to attach the imaging unit 11 to the camera main body 13. Through the concave connectors 46, the imaging unit 11 and the camera main body 13 are electrically connected to transmit various signals between them. To the convex connectors 17a and 17b, a clicking mechanism (not shown) is provided. The clicking mechanism projects into a groove section of the concave connector 46 when the convex connectors 17a and 17b are connected to the concave connector 46, so that the imaging unit 11 is prevented from dropping from the camera main body 13. Note that instead of or in addition to the clicking mechanism, for example a drop-preventing mechanism including a projection and a lid may be provided to the camera main body 13. Note that also the imaging unit 12 has the convex connectors 17a and 17b same as provided in the imaging unit 11.

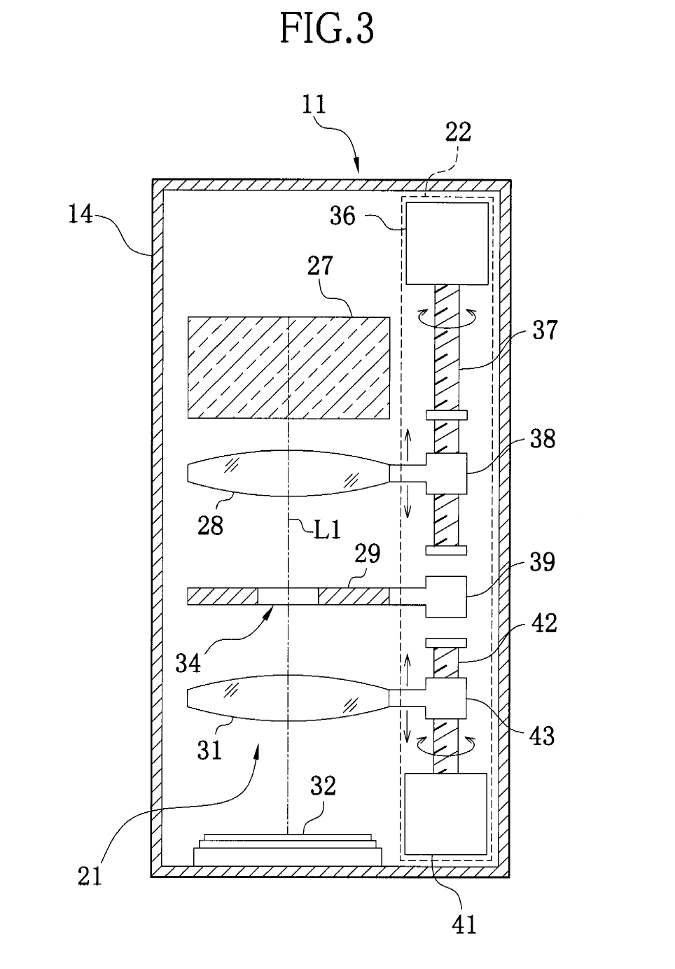

As shown in FIG. 3 and FIG. 4, the imaging unit 11 comprises the case 14, and the imaging optical system 21 and an optical system driver 22 contained in the case 14.

The imaging optical system 21 includes for example the objective lens 26, a prism 27, a zoom lens 28, an aperture stop 29, a focus lens 31 and so on.

The objective lens 26 leads subject light entered from a unit opening 33 toward the prism 27. The prism 27 is formed into a triangular prism shape, and refracts the light entered along an optical axis L1 to a light-receiving surface of a CCD 32 (image pickup element) positioned below the prism 27.

The zoom lens 28 is positioned close to the prism 27, between the prism 27 and the CCD 32. The zoom lens 28 is movable along the optical axis L1 refracted by the prism 27, to change the imaging magnification. The aperture stop 29 is provided below the zoom lens 28, and is operated by halfway-press of a release button 47 (described later), to change a size of an aperture opening 34. Accordingly, light amount for imaging is controlled.

The focus lens 31 is positioned between the aperture stop 29 and the CCD 32, and movable along the optical axis L1 refracted by the prism 27. The focus lens 31 is operated for focusing according to change of the imaging magnification by the movement of the zoom lens 29, or according to the halfway-press of the release button 47. The CCD 32 photoelectrically converts the subject light into analog image signal on the light-receiving surface, and outputs the analog image signal to the camera main body 13 through the convex connector 17b.

The optical system driver 22 includes a zoom motor 36, a zoom lead screw 37, a zoom carriage 38, an aperture motor 39, a focus motor 41, a focus lead screw 42 and a focus carriage 43.

The zoom lead screw 37 and the focus lead screw 42 are arranged parallel to the optical axis L1 refracted by the prism 27. To the zoom lead screw 37, a female screw portion of the zoom carriage 38 is threaded. The zoom lead screw 37 is rotated by the zoom motor 36. The zoom carriage 38 is movably attached along the optical axis L1, and is not rotatable around the zoom lead screw 37. Accordingly, when the zoom lead screw 37 is rotated, the zoom carriage 38 is moved along the optical axis L1. The zoom carriage 38 holds the zoom lens 28, so that the zoom lens 28 can be moved to change the imaging magnification.

Likewise, to the focus lead screw 42, a female screw portion of the focus carriage 43 is threaded. The focus lead screw 42 is rotated by the focus motor 41. The focus carriage 43 is movably attached along the optical axis L1, and is not rotatable around the focus lead screw 42. Accordingly, when the focus lead screw 42 is rotated, the focus carriage 43 is moved along the optical axis L1. The focus carriage 43 holds the focus lens 31, so that the focus lens 31 can be moved for focusing.

The aperture motor 39 changes the size of the aperture opening 34, so that a desirable amount of subject light reaches the light-receiving surface of the CCD 32.

In the case 14, the imaging optical system 21 is positioned on the left side, and the optical system driver 22 is positioned on the right side, viewed from the front face 16a. Accordingly, the objective lens 26 of the imaging optical system 21 is positioned to the left from the center of the front face 16a. In addition, the objective lens 26 is positioned in the upper side in the case 14, so that the objective lens 26 is positioned on the upper side from the center of the front face 16a. According to these off-center arrangements, the objective lens 26 is positioned near to the upper left corner of the front face 16a.

The second imaging unit 12 has the same configuration as the first imaging unit 11, where the objective lens 26 is on the front face 16a, and the convex connectors 17a and 17b are on the rear face 16c. However, in the second imaging unit 12, the objective lens 26 is arranged near to an upper right corner, and the first imaging unit 11 and the second imaging unit 12 are symmetrical.

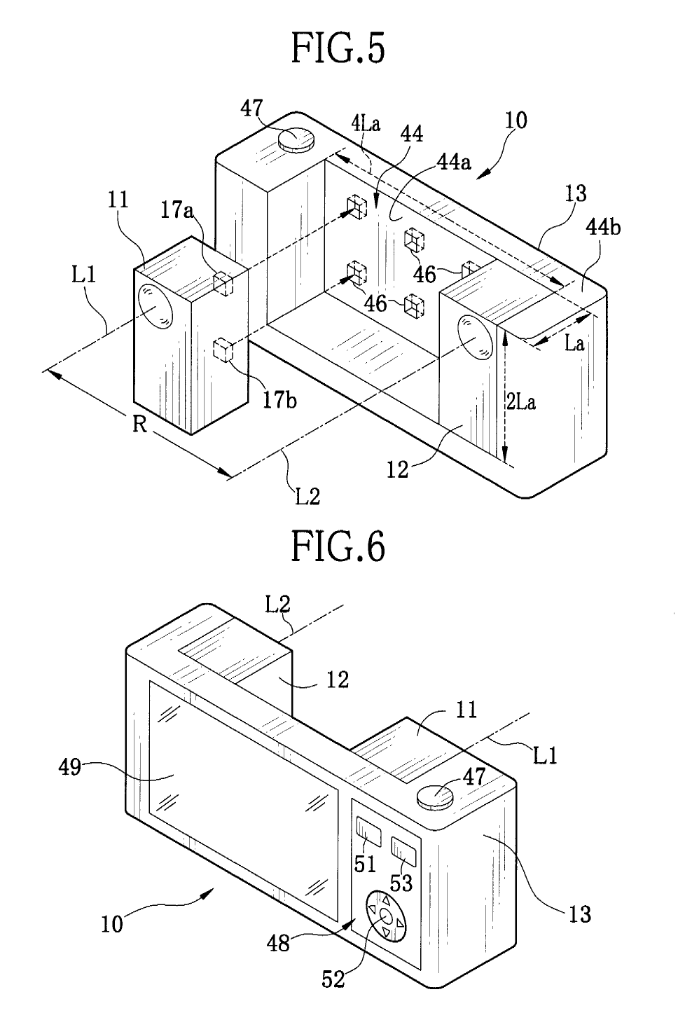

As shown in FIG. 5, on a center section of the camera main body 13, there is a concave container portion 44 of a rectangular parallelepiped shape. The concave container portion 44 opens on a front face 44a (the attachment face) and an upper face 44b, and has a size (length: 2La (=Lb), width: 4La (=2Lb), depth: La) that can contain four of the imaging units at once.

On the front face 44a of the concave container portion 44, concave connectors 46 (the second connectors) are formed. Into the concave connectors 46, the convex connectors 17a and 17b of the imaging units 11 and 12 are inserted to make electrical connection. The concave connectors 46 are arranged on positions corresponding to the convex connectors 17a and 17b of the imaging units in the vertical orientation and the convex connectors 17a and 17b of the imaging units in the horizontal orientation. Accordingly, the imaging units 11 and 12 can be contained in the concave container portion 44 either in the vertical or horizontal orientation.

The concave connector 46 has a square opening, and on each side face of the concave connector 46, there are a connecting terminal and a detecting terminal. The camera main body 13 detects the orientation of the imaging unit according to which side face of the concave connectors 46 is touching the terminals of the convex connectors 17a and 17b. For example, when the terminals on the upper faces of the concave connectors 46 and the terminals of the convex connectors 17a and 17b are connected, it is found that the imaging unit is in a vertical upright orientation. When the terminals on the lower faces of the concave connectors 46 and the terminals of the convex connectors 17a and 17b are connected, it is found that the imaging unit is in a vertical inverted orientation. When the terminals on the right faces of the concave connectors 46 and the terminals of the convex connectors 17a and 17b are connected, it is found that the imaging unit is in a horizontal right orientation. When the terminals on the left faces of the concave connectors 46 and the terminals of the convex connectors 17a and 17b are connected, it is found that the imaging unit is in a horizontal left orientation. Further, since the two convex connectors 17a and 17b are used, the camera main body 13 detects the attached position of the imaging unit according to the positions of the two concave connectors 46 into which the convex connectors 17a and 17b are inserted. In addition, the camera main body 13 detects the type of the imaging unit (whether the connected imaging unit is the first imaging unit 11 or the second imaging unit 12) based on a detection signal received through the detecting terminal. The camera main body 13 distinguishes the position of the optical axis of the connected imaging unit (for example the optical axis L1 of the imaging unit 11 or the optical axis L2 of the imaging unit 12) based on the detected results of the type, the attached position and the orientation of the imaging unit.

The camera main body 13 supplies electric power to the imaging unit 11 through the connection between the connecting terminals of the concave connector 46 and the convex connectors 17a, 17b. Further, through the connection between the connecting terminals, the camera main body 13 sends operation signals to the imaging unit 11 and receives image signals from the imaging unit 11. The operation signals may be, for example, a zoom signal for operating the zoom motor 36, a light amount controlling signal for operating the aperture stop 29, a focus signal for operating the focus motor 41, a CCD drive signal for driving the CCD 32 and so on.

In this specification, a base length means a length between imaging optical axes of a pair of the imaging units, when the pair of the imaging units are used to obtain two parallax images. For example, as shown in FIG. 5, when the first and second imaging units 11 and 12 both in the vertical upright orientation are attached on the leftmost side and the rightmost side of the concave container portion 44 respectively, a base length R is a length between the optical axis L1 of the first imaging unit 11 and the optical axis L2 of the second imaging unit 12.

On the upper face 44b of the camera main body 13, the release button 47 is provided for imaging operation of the multi-eye camera 10. The release button 47 is a part of an operating section 48 (described later). The release button 47 can be pressed in two steps (half-pressed and full-pressed). When the release button 47 is half-pressed, focusing and light amount adjustment are performed automatically in the imaging unit attached to the camera main body 13. Then when the release button 47 is full-pressed, imaging is performed to obtain a subject image.

As shown in FIG. 6, on a rear face of the camera main body 13, there are the operating section 48 for operating the multi-eye camera 10 and a display panel 49.

The display panel 49 functions as an electronic viewfinder which displays a through image with low resolution in real time while the imaging operation, and as a display which displays the images stored in a storage medium such as a memory card. In addition, the display panel 49 displays a menu and so on for changing settings of the multi-eye camera 10 according to operation on the operating section 48.

The display panel 49 is a liquid-crystal display with using a parallax barrier. As display modes, there are a stereo display mode and a plane display mode. In the stereo display mode, a through image or the stored image in the memory card is displayed such that the user can view the image stereoscopically.

In detail, the display panel 49 has a parallax barrier display layer and a liquid-crystal display layer. In the stereo display mode, the parallax barrier is formed on the parallax barrier display layer, and strip-shaped (narrow-rectangular) image fragments, which represent a right-eye image and a left-eye image, are alternately arranged according to pitches of the parallax barrier and displayed on the liquid-crystal layer.

In the plane display mode, the parallax barrier is not formed on the parallax barrier display layer, and a normal plane image is displayed on the liquid-crystal layer. In addition, the display panel 49 has other display modes such as a multiple-display mode for displaying a plurality of reduced images, and an overlap display mode for displaying an overlapping image of several translucent images.

The display mode of the display panel 49 can be changed by operation of the operating section 48. In addition, the display mode can be automatically changed according to use condition of the display panel 49. For example, a through image is displayed in the stereo display mode, and menus and so on are displayed in the plane display mode.

The operating section 48 includes the aforementioned release button 47, and a menu button 51, a multifunction key 52 and a power button 53 which are provided on the rear face of the camera main body 13.

By pressing the menu button 51, operation menus for the multi-eye camera 10 are displayed on the display panel 49. As the operation menus, there are a selection menu for determining an imaging mode for imaging a subject, a selection menu for determining the display mode of the display panel 49, a selection menu for determining recording mode for recording a captured image, and so on.

As the imaging modes, there are a single-eye imaging mode for imaging a subject with use of the single imaging unit, and multi-eye imaging modes for imaging a subject with use of the plurality of imaging units. In the single-eye imaging mode, one of the imaging units attached to the multi-eye camera 10 is used for capturing a subject image.

As the multi-eye imaging modes, there are a three-dimensional mode for obtaining a three-dimensional image with use of the plurality of imaging units, and special imaging modes for applying special processes to obtained images. As the special imaging modes, there are a panoramic mode, a pan-focus mode, a dynamic range expansion mode, a special effect mode, a multi-zoom mode, a continuous image-capturing mode and so on.

In the three dimensional mode, the plurality of imaging units with the same imaging condition capture a subject at the same time to obtain a plurality of images from different view points (with parallax to each other). These obtained images are related and stored in the storage medium such as the memory card. From these images, three-dimensional data of the subject image is obtained by image processing, or a special synthetic image is created.

In the panoramic mode, two of the imaging units with the same imaging condition capture an image at the same time to obtain partly overlapped two images. Since the overlapped image area is trimmed from one of the images and then the two images are combined, a panoramic image whose image area is larger than an image captured by the single imaging unit is formed.

In the pan-focus mode, the plurality of imaging units capture images at the same time at different focus positions, and a composite image having a large focused area is composed from these images.

In the dynamic range expansion mode, the plurality of imaging units capture images at the same time under different exposure conditions, and these images are combined to compose one image with a broad dynamic range.

In the special effect mode, the plurality of imaging units with the same imaging condition capture a subject at the same time to obtain a plurality of images with parallax to each other. Then three-dimensional data is automatically extracted to compose one image with low depth of field, that is, an image whose main subject is emphasized by blurring a background area is composed.

In the multi-zoom mode, the plurality of imaging units captures images at the same time with different view angles. Then an image in which a main subject is imaged at high resolution is composed from the obtained images.

In the continuous image-capturing mode, the plurality of imaging units are driven one-by-one at predetermined time intervals to obtain continuous images.

The multifunction key 52 functions as a cross key to move a cursor to each item of the menu on the display panel 49 for setting of the multi-eye camera 10, and functions as an enter key to determine the item when the center of the multifunction key 52 is pressed. Further, the multifunction key 52 functions as a zoom key to enlarge or reduce the image area for image capturing. In addition, the multifunction key 52 functions as a frame-advancing key and so on when the images read from the memory card 54 or the like are displayed on the display panel 49.

When the power button 53 is pressed for a certain period of time, the multi-eye camera 10 is turned on or off. Note that the multi-eye camera 10 is powered by an internal battery (not shown) or the like.

On a side face of the camera main body 13, there are a memory card slot (not shown), a plurality of external connection terminals (not shown) for connection between the multi-eye camera 13 and external equipments, and so on. To the memory card slot, the memory card 54 for storing captured images and soon is inserted. The external equipments may be, for example, an external power supply, a computer and so on.

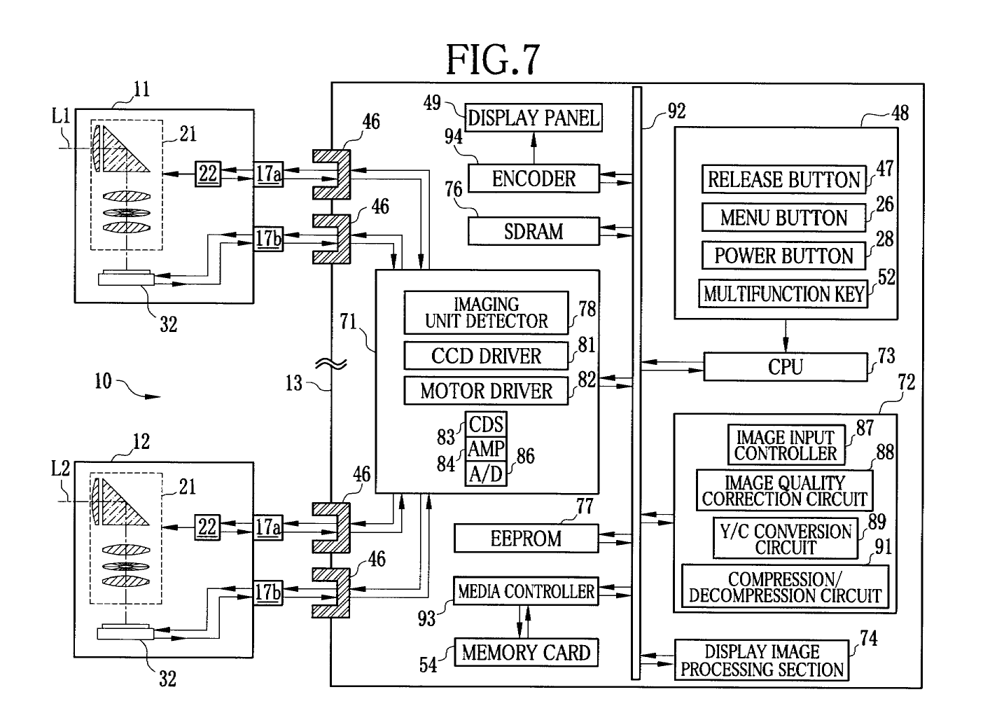

As shown in FIG. 7, the multi-eye camera 10 comprises an imaging unit driving section 71 (unit controller), a DSP (Digital Signal Processor) 72, a CPU 73, a display image processing section 74, an SDRAM 76, an EEPROM 77 and so on.

The imaging unit driving section 71 includes one imaging unit detector 78 and sets of a CCD driver 81, a motor driver 82, a correlated double sampling circuit (CDS) 83, a signal amplifier (AMP) 84, and an A/D converter (A/D) 86. Each set is for each imaging unit attached to the camera main body 13. Accordingly, the multi-eye camera 10 to which four imaging units can be attached at the same time has four sets of the CCD driver 81, the motor driver 82, the CDS 83, the AMP 84, and the A/D 86. This composition enables to drive the plural imaging units at the same time for simultaneous image-capturing and so on.

The imaging unit detector 78 detects the attached position and the orientation of the imaging units. Concretely, the imaging unit detector 78 judges on which face of the concave connectors 46 the detecting terminals are touching the convex connectors 17a and 17b of the imaging unit. Further, the imaging unit detector 78 receives the detection signal through the connection between the detecting terminals of the concave connectors 46 and the convex connectors 17a and 17b. As the detection signal, there are a unit type signal for detecting the type of the connected imaging unit, an ID signal of the connected imaging unit and so on. Based on these signals, the imaging unit detector 78 finds the convex connectors 17a and 17b of the same imaging unit, and attached positions of these convex connectors. Accordingly, the attached position and the orientation of the imaging unit can be detected. In addition, the imaging unit detector 78 finds the position of the optical axis of the attached imaging unit based on the detected type, attached position and orientation of the attached imaging unit. Note that information such as the types, numbers, attached positions and orientations, positions of the optical axes and so on are stored in the SDRAM 76.

The CCD driver 81 drives the CCD of the imaging unit detected by the imaging unit detector 78, through the concave connector 46 and the convex connector 17b. The CPU 73 controls the CCD driver 81. When the plurality of the imaging units are connected to the camera main body 13, the CCD 73 determines that which of the four CCD drivers 81 in the imaging unit driving section 71 drives the CCD of which imaging unit.

The motor driver 82 drives the zoom motor 36, the aperture motor 39 and the focus motor 41. The CPU 73 controls the motor driver 82. For example, the CPU 73 determines driving order, amount and so on of each motor.

The CDS 83 receives an analog image signal from the CCD 32 in image capturing, removes noises from the image signal, and outputs the image signal to the AMP 84. The AMP 84 amplifies the analog image signal whose noises are removed and outputs it to the A/D 86. The A/D 86 converts the amplified analog image signal into digital image data, and outputs it to the DSP 72. This digital image data from the A/D 86 is the image data of R, G, and B signals exactly corresponding to the accumulated charge of each cell of the CCD 32.

The DSP 72 is composed of an image input controller 87, an image quality correction circuit 88, an Y/C conversion circuit 89, a compression/decompression circuit 91 and so on. The DSP 72 stores the image data of RGB inputted from the A/D 86 in the SDRAM 76 temporarily, and then applies various image processes to the image data.

The DSP 72 is connected to an AE/AWB detector (not shown) and an AF detector (not shown) through a data bus 92. The AE/AWB detector detects an exposure amount (an shutter speed of an electronic shutter) and a size of the aperture opening 34 of each imaging unit used for imaging, to determine whether these conditions are appropriate or not for imaging. The AF detector detects whether focusing control of each imaging unit used for imaging is appropriate or not for imaging.

The image input controller 87 performs buffering of the image data from the A/D 86, and stores the data in the SDRAM 76 through the data bus 92. The image quality correction circuit 88 reads the image data from the SDRAM 76, applies image processes such as gradation conversion, white balance correction and gamma correction to the image data, and stores the data to the SDRAM 76 again. The Y/C conversion circuit 89 reads the processed image data from the SDRAM 76 and converts it to luminance signal Y and color difference signals Cr, Cb. The compression/decompression circuit 91 compresses the Y/C converted image data to a predetermined file format such as JPEG or TIFF, and outputs it. The compressed image data is stored in the memory card 54 through a media controller 93.

The imaging unit driving section 71 obtains principal image data having large number of pixels from the connected imaging unit when the release button 47 is pressed. While the display panel 49 is used as the electronic viewfinder, the imaging unit driving section 71 obtains through-image data having small number of pixels. The through-image data is obtained in frame rate of 30 frames/sec. The through-image data is subjected to the various image processes as same as the principal image data by the DSP 72, and then stored in the SDRAM 76 temporarily. After that, in contrast to the principal image data which is stored in the memory card 54 after the above image processes, the through-image data is read out by the display image processing section 74 to be subject to image processes for through-image display, converted to analog composite signal by an encoder 94 and then video-outputted to the display panel 49. In the SDRAM 76, there is a VRAM area for storing the through-image data, so that the through image in the VRAM area is continually updated at the above-described frame rate and outputted to the display panel 49.

The display image processing section 74 applies image processes to the image data stored in the SDRAM 76, the memory card 54 or so on according to the pre-selected display mode of the display panel 49, and displays the processed image on the display panel 49 through the encoder 94.

When the display panel 49 is in the stereo display mode, the display image processing section 74 forms the parallax barrier on the parallax barrier display layer, and reads image data for stereo display from the SDRAM 76, the memory card 54 or so on to composite single stereo image data in which strip-shaped image fragments representing a right-eye image and a left-eye image are alternately arranged according to pitches of the parallax barrier. The stereo image is displayed on the liquid-crystal layer of the display panel 49 through the encoder 94.

When the display panel 49 is in the plane display mode, the display image processing section 74 reads image data for plane display from the SDRAM 76, the memory card 54 or so on, without forming the parallax barrier on the parallax barrier display layer. The plane image is displayed on the liquid-crystal layer of the display panel 49 through the encoder 94.

When the display panel 49 is in the multiple-display mode, the display image processing section 74 reads the image data of predetermined number of images from the SDRAM 76, the memory card 54 or so on, and forms one multiple-display image in which the plurality of reduces images are arranged. The multiple-display image is displayed on the liquid-crystal layer of the display panel 49 through the encoder 94.

When the display panel 49 is in the overlap display mode, the display image processing section 74 reads the image data of predetermined number of images from the SDRAM 76, the memory card 54 or so on, and forms one overlapping image in which the plurality of translucent images are overlapped. The overlapping image is displayed on the liquid-crystal layer of the display panel 49 through the encoder 94.

When the display panel 49 is used as the electronic viewfinder for displaying the through image while image capturing, the display image processing section 74 reads through-image data from the VRAM area of the SDRAM 76 every time the through-image data is updated. Then the image processes according to the selected display mode are applied to the through-image data, and the through image is displayed on the liquid-crystal layer of the display panel 49 through the encoder 94.

The CPU 73 reads control programs for controlling the multi-eye camera 10 from the EEPROM 77, and executes these programs. Following the operations on the operating section 48, the CPU 73 controls each section of the multi-eye camera 10. Further, the CPU 73 drives each section of the imaging unit driving section 71 to control the imaging units connected to the multi-eye camera 10, based on the detection results of the AE/AWB detector and the AF detector. In addition, the CPU 73 distinguishes a pair of the imaging units to capture two parallax images and the base length in between based on the detection result of the imaging unit detector 78. The two captured images, information for relating the two images and information of imaging conditions such as the base length are stored in the SDRAM 76 by the CPU 73.

The CPU 73 finds a number of the imaging units attached to the camera main body 13, and the attached position and orientation of each imaging unit based on the detection result of the imaging unit detector 78. According to these conditions, the CPU 73 determines the operation order of the imaging units, the imaging unit for obtaining the through-image data to be displayed on the display panel 49 as the electronic viewfinder, and so on.

The SDRAM 76 is a work memory for temporarily storing image data and setting information of the multi-eye camera 10 and for loading control programs executed by the CPU 73. In the EEPROM 77, control programs for controlling each section of the multi-eye camera 10 executed by the CPU 73, setting information of the multi-eye camera 10, and so on are stored.

Next, the operation of the multi-eye camera 10 is explained. When the multi-eye camera 10 is used as the single-eye digital camera as same as a general digital camera, one imaging unit is attached to the camera main body 13, or one of the plurality of imaging units attached to the multi-eye camera 10 is selected to perform image capturing. At this time, the attached position and orientation of the imaging unit are not limited.

When the multi-eye camera 10 is used for obtaining a pair of parallax images, or in the imaging mode in which a special image is composed from a plurality of images obtained at the same time, two or more imaging units are attached to the camera main body 13.

When the two imaging units are attached to the camera main body 13, there are the cases that the two imaging units of the same type are used and that the two imaging units of different types are used.

As described above, the front face of the imaging unit has the short side whose length is La and the long side whose length is Lb=2La. Hereinafter, the distance between the optical axis of the imaging unit and the long side nearest to the optical axis is denoted by Lp, and the distance between the optical axis and the short side nearest to the optical axis is denoted by Lq.

When the two imaging units of the same type are used, for example an imaging unit 96, whose optical axis arrangement and configuration are the same as the imaging unit 11, is used with the imaging unit 11. For example, as shown in FIG. 8, the imaging units 11, 96 both in the vertical upright orientation are attached to the camera main body 13, such that the optical axis L1 of the imaging unit 11 and the optical axis L3 of the imaging unit 96 are positioned farthest to each other. That is, there is a space equivalent to two imaging units between the imaging units 11 and 96.

At this time, a base length R2 between the optical axes L1 and L3 is 3La, which is the longest base length when the two imaging units of the same type are used. Accordingly, this arrangement of the imaging units is suitable for image capturing of a relatively distant landscape or subject. In addition, since the optical axes L1 and L3 of the imaging units 11 and 96 are on a line in the vertical direction and are apart each other in the horizontal direction, a pair of parallax images in the horizontal direction can be obtained when the same subject is captured with the imaging units 11 and 96 at the same time.

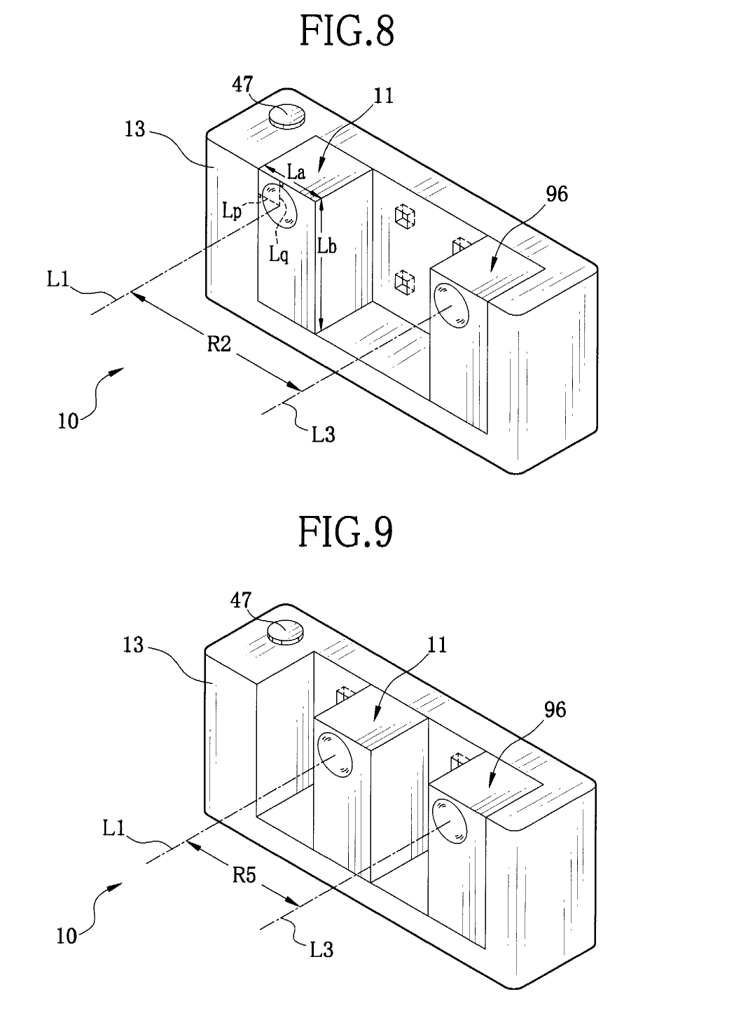

For another example, as shown in FIG. 9, the imaging units 11, 96 both in the vertical upright orientation are attached to the camera main body 13, such that a space equivalent to one imaging unit is created between the imaging units 11 and 96.

At this time, a base length R5 between the optical axes L1 and L3 is 2La, which is shorter by La than the base length R2. Accordingly, this arrangement of the imaging units is suitable for image capturing of a middle-distance landscape or subject. Note that in FIG. 9, the imaging unit 11 is moved by the distance of one imaging unit toward the imaging unit 96, compare to FIG. 8. However, it is possible to move the imaging unit 96 by the distance of one imaging unit toward the imaging unit 11. Even in this case, the length between the optical axes L1 and L3 is also the base length R5.

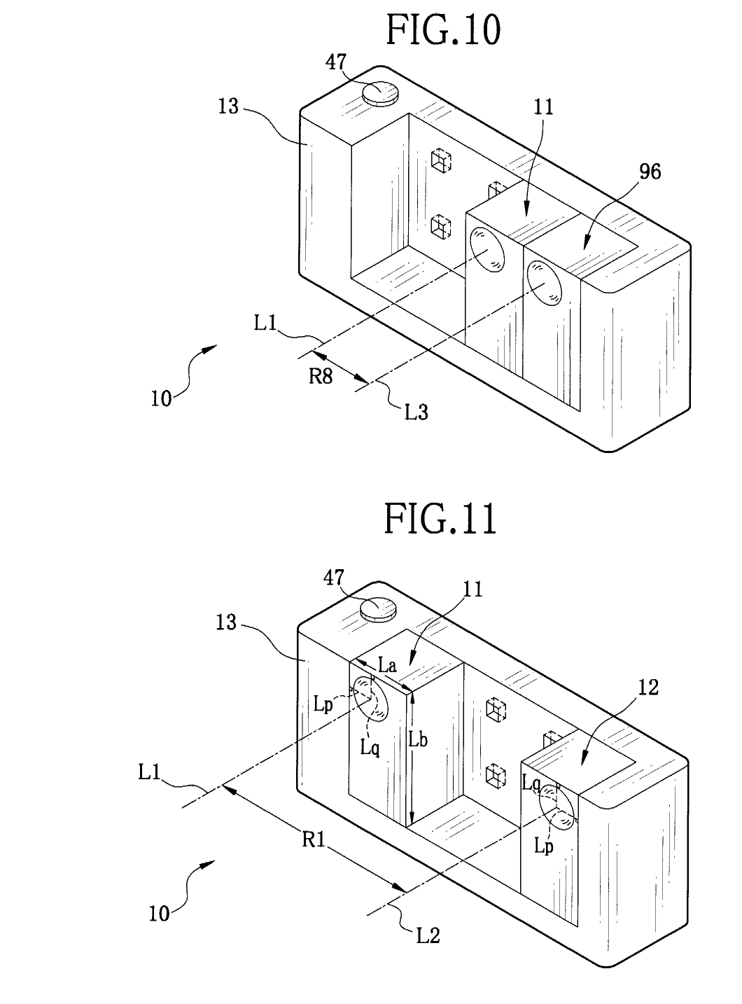

For still another example, as shown in FIG. 10, the imaging units 11, 96 both in the vertical upright orientation are attached to the camera main body 13, such that there is no space between the imaging units 11 and 96.

At this time, a base length R8 between the optical axes L1 and L3 is La, which is the shortest base length when the two imaging units of the same type are used. Accordingly, this arrangement of the imaging units is suitable for image capturing of a relatively close landscape or subject. Note that although there are three positions in which the imaging units 11 and 96 in the vertical orientation are adjacent, any of these positions can be selected because the base length is always R8.

When the two imaging units of different types are used, for example, the imaging unit 12 is used with the imaging unit 11. As described above, the imaging unit 12 has the imaging optical system 21 and the optical system driver 22 at inverted positions to those of the imaging unit 11. Since the position of the optical axis of the imaging unit 12 is different from that of the optical axis of the imaging unit 11, the combination of the imaging units 11 and 12 provides further length variations of the base length for image capturing.

For example, as shown in FIG. 11, the imaging units 11, 12 both in the vertical upright orientation are attached to the camera main body 13, such that the optical axis L1 of the imaging unit 11 and the optical axis L2 of the imaging unit 12 are positioned farthest to each other. That is, there is a space equivalent to two imaging units between the imaging units 11 and 12.

At this time, a base length R1 between the optical axes L2 and L2 is 4La−2Lp, which is longer than the base length R2 and is the longest base length when the two imaging units are used. Accordingly, this combination and arrangement of the imaging units is suitable for image capturing of a very distant landscape or subject, among any other combination and arrangement of the imaging units.

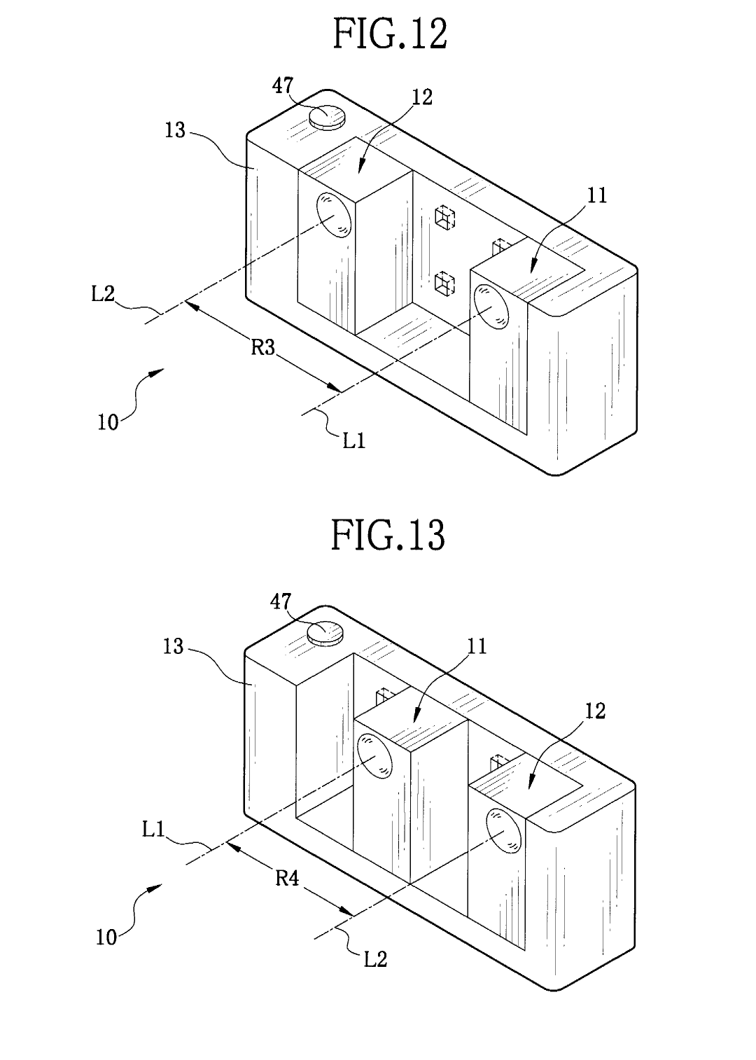

For another example, as shown in FIG. 12, the positions of the imaging units 11 and 12 are switched from the arrangement in FIG. 11. At this time, a base length R3 between the optical axes L1 and L2 is 2La+2Lp, which is shorter than the base lengths R1 and R2, and is longer than the base length R5. Accordingly, this arrangement of the imaging units having the base length R3 is suitable for image capturing of a nearer landscape or subject, when compared to the arrangement of the imaging units having the base length R1.

For still another example, as shown in FIG. 13, the imaging units 11, 12 both in the vertical upright orientation are attached to the camera main body 13, such that a space equivalent to one imaging unit is created between the imaging units 11 and 12 and the optical axes L1 and L2 are as apart from each other as possible. At this time, a base length R4 between the optical axes L1 and L2 is 3La−2Lp, which is shorter than the base length R3. Accordingly, this arrangement of the imaging units having the base length R4 is suitable for image capturing of a nearer landscape or subject, when compared to the arrangement of the imaging units having the base length R3.

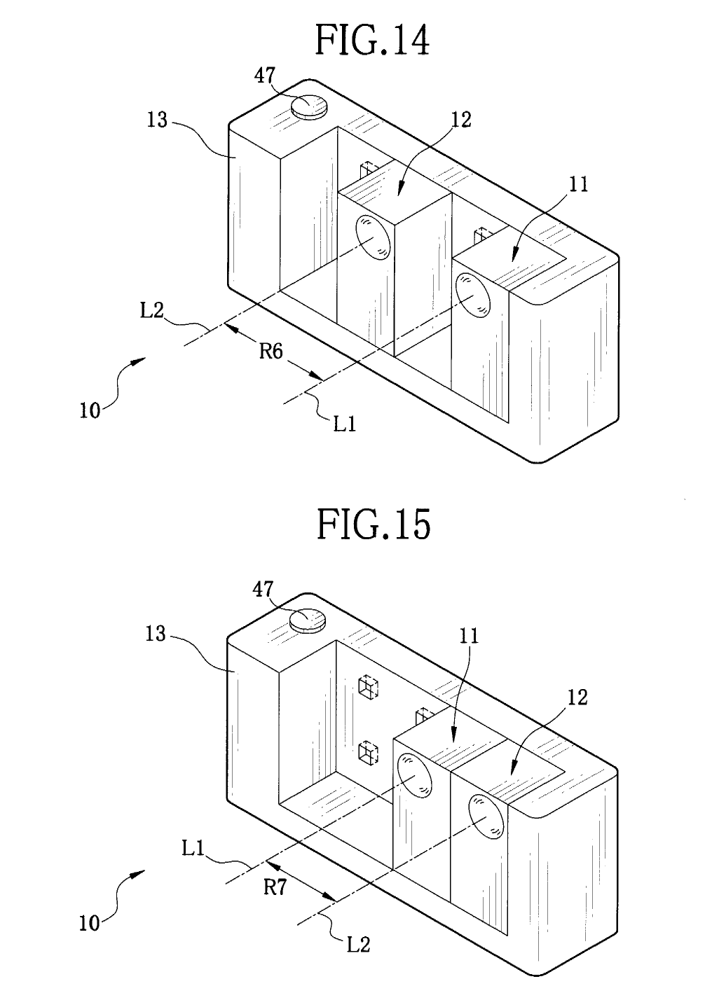

For still another example, as shown in FIG. 14, the imaging units 11, 12 both in the vertical upright orientation are attached to the camera main body 13, such that a space equivalent to one imaging unit is created between the imaging units 11 and 12 and the optical axes L1 and L2 are as close to each other as possible. At this time, a base length R6 between the optical axes L1 and L2 is La+2Lp, which is shorter than the base length R4. Accordingly, this arrangement of the imaging units having the base length R6 is suitable for image capturing of a nearer landscape or subject, when compared to the arrangement of the imaging units having the base length R4.

For still another example, as shown in FIG. 15, the imaging units 11, 12 both in the vertical upright orientation are attached to the camera main body 13, such that the imaging units 11 and 12 lie adjacent to each other and the optical axes L1 and L2 are as apart as possible. At this time, a base length R7 between the optical axes L1 and L2 is 2La−2Lp, which is shorter than the base length R6. Accordingly, this arrangement of the imaging units having the base length R7 is suitable for image capturing of a nearer landscape or subject, when compared to the arrangement of the imaging units having the base length R6.

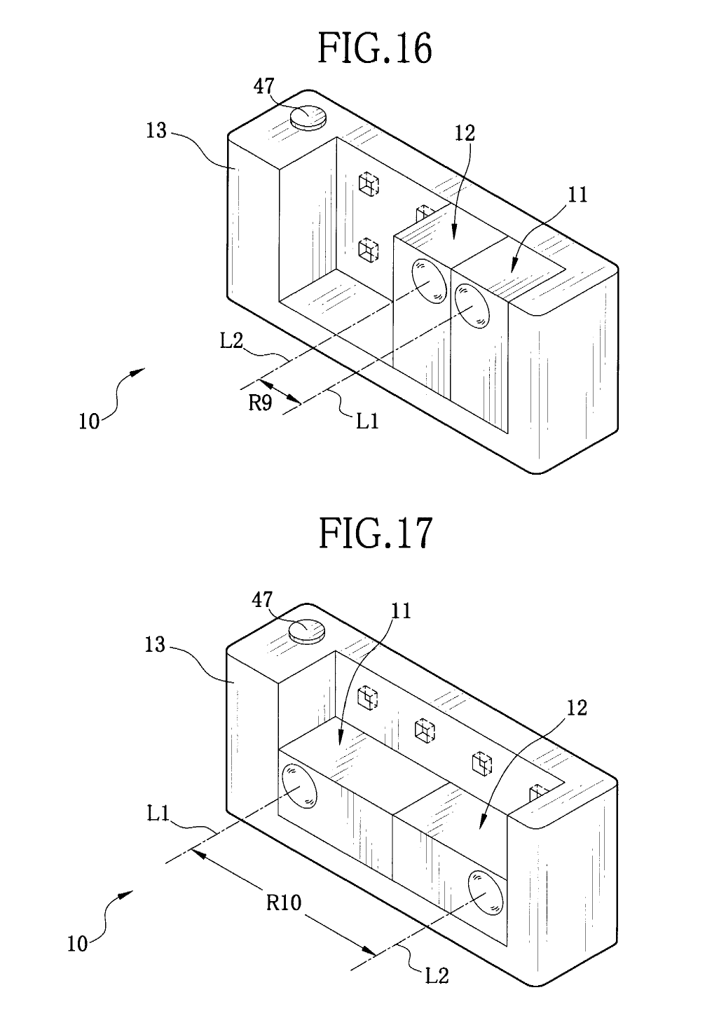

For yet still another example, as shown in FIG. 16, the imaging units 11, 12 both in the vertical upright orientation are attached to the camera main body 13, such that the imaging units 11 and 12 lie adjacent to each other and the optical axes L1 and L2 are as close as possible. At this time, a base length R9 between the optical axes L1 and L2 is 2Lp, which is shorter than the base length R7 and is the shortest base length when the two imaging units are used. Accordingly, this combination and arrangement of the imaging units is suitable for image capturing of a very close landscape or subject, among any other combination and arrangement of the imaging units.

As described above, since the multi-eye camera 10 can change the combinations of the types, the attachment position and orientation of the two imaging units, the appropriate base length for imaging can be selected according to the distance to the subject.

The selectable base lengths are R1, R2, R3, R4, R5, R6, R7, R8 and R9. When the imaging unit satisfies Lp<La/4, the order of lengths becomes R1>R2>R3>R4>R5>R6>R7>R8>R9.

When the imaging unit satisfies Lp=La/4, the selectable base lengths are R1, R2, R3=R4, R5, R6=R7, R8, R9. The order of lengths becomes R1>R2>R3=R4>R5>R6=R7>R8>R9. Accordingly, the multi-eye camera 10 still can select one of the seven base lengths. In this case, since R1 is seven times longer than R9, the multi-eye camera 10 can adjust to various distances to the subject.

When the imaging units 1 and 12 are made to have different lengths of Lp to each other, the option of the base lengths is increased and the multi-eye camera 10 can perform finer distance adjustment to a subject.

In each embodiment described above, the imaging optical system 21 is a bending optical system with use of the prism for bending the optical axis. Accordingly, the thickness of the imaging unit can be reduced, and portability of the multi-eye camera 10 can be increased.

In the above embodiments, the two imaging units are used in the vertical orientation. However, the two imaging units can be used in the horizontal orientation.

For example, as shown in FIG. 17, the imaging units 11, 12 both in the horizontal orientation are attached to the camera main body 13, such that the optical axis L1 of the imaging unit 11 and the optical axis L2 of the imaging unit 12 are positioned farthest to each other. At this time, the length between the optical axes L1 and L2 (a base length R10) is 4La−2Lq. When Lp≠Lq, the base length R10 is different from the base lengths R1 to R9. Accordingly, the option of the base lengths is further increased.

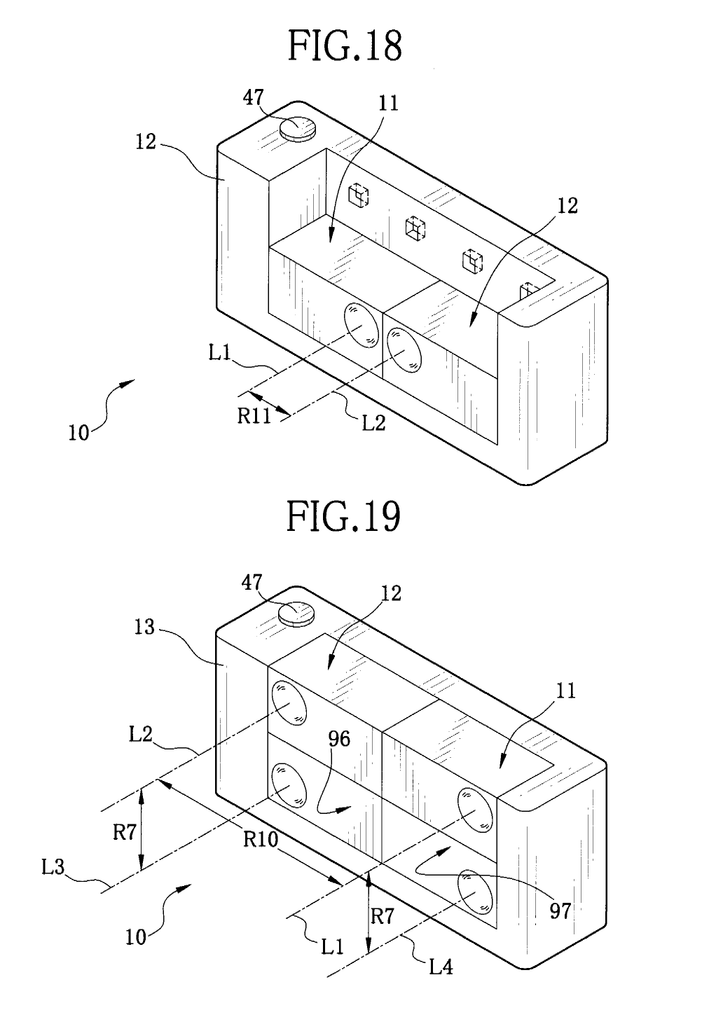

In the same manner, as shown for example in FIG. 18, the imaging units 11, 12 both in the horizontal orientation are attached to the camera main body 13, such that the optical axis L1 of the imaging unit 11 and the optical axis L2 of the imaging unit 12 are closest to each other. At this time, the length between the optical axes L1 and L2 (a base length R11) is 2Lq. When Lp≠Lq, the base length R11 is different from the base lengths R1 to R10. Accordingly, the option of the base lengths is further increased.

In the above embodiments, the two imaging units are attached to the camera main body 13. However, four imaging units can be used at the same time. For example, as shown in FIG. 19, an imaging unit 97 whose optical axis arrangement and configuration are the same as the imaging unit 12 is used with the imaging units 11, 12 and 96.

In FIG. 19, the imaging units 11, 12 both in the horizontal orientation are attached to the camera main body 13, such that the optical axis L1 of the imaging unit 11 and the optical axis L2 of the imaging unit 12 are positioned farthest to each other. In addition, the imaging unit 96 below the imaging unit 12 and the imaging unit 97 below the imaging unit 11 both in the horizontal orientation are attached to the camera main body 13, such that the optical axis L3 of the imaging unit 96 and the optical axis L4 of the imaging unit 97 are positioned farthest to each other.

At this time, the length between the optical axes L1 and L2 is the base length R10. A pair of parallax images in the horizontal direction can be obtained by image capturing with use of the imaging units 11 and 12. In the same manner, the length between the optical axes L3 and L4 is the base length R10. A pair of parallax images in the horizontal direction can be obtained by image capturing with use of the imaging units 96 and 97.

On the other hand, the length between the optical axes L1 and L4 is the base length R7. A pair of parallax images in the vertical direction can be obtained by image capturing with use of the imaging units 11 and 97. In the same manner, the length between the optical axes L2 and L3 is the base length R7. A pair of parallax images in the vertical direction can be obtained by image capturing with use of the imaging units 12 and 96.

The base length R10 is the longest base length when the two imaging units in the horizontal orientation are arranged horizontally. In addition, the base length R7 is the longest base length when the two imaging units in the horizontal orientation are arranged vertically. Accordingly, this arrangement of the imaging units is suitable for image capturing of a distant landscape or subject.

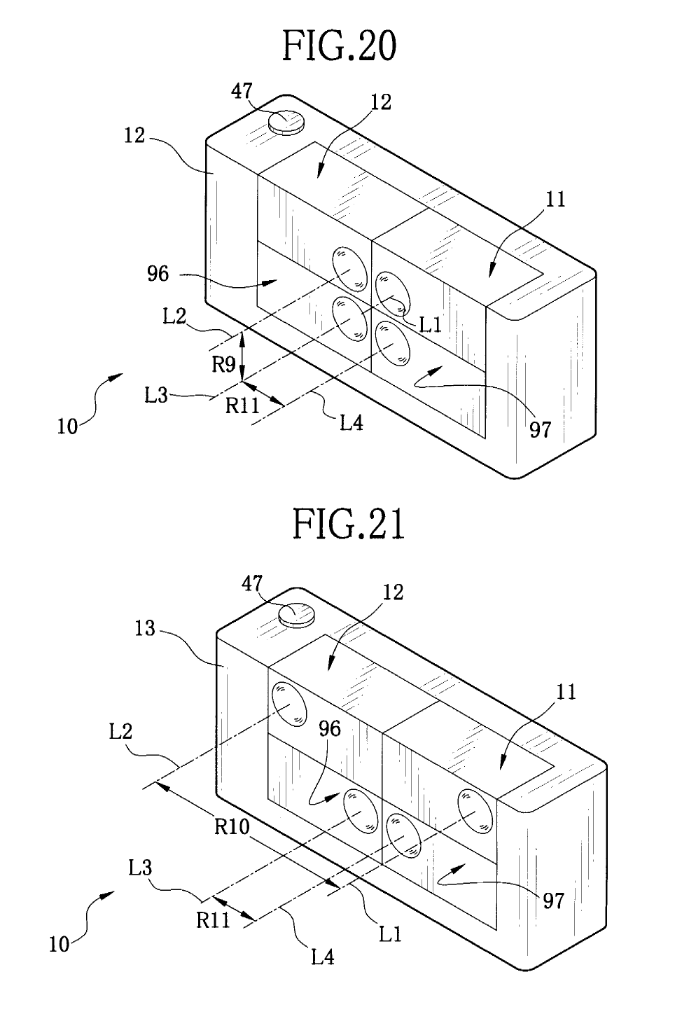

For another example, as shown in FIG. 20, the imaging units 11 and 12 in the horizontal orientation are attached to the camera main body 13, such that the optical axis L1 of the imaging unit 11 and the optical axis L2 of the imaging unit 12 are closest to each other. In addition, the imaging unit 96 below the imaging unit 12 and the imaging unit 97 below the imaging unit 11 both in the horizontal orientation are attached to the camera main body 13, such that the optical axis L3 of the imaging unit 96 and the optical axis L4 of the imaging unit 97 are closest to each other.

At this time, the length between the optical axes L1 and L2 is the base length R11. A pair of parallax images in the horizontal direction can be obtained by image capturing with use of the imaging units 11 and 12. In the same manner, the length between the optical axes L3 and L4 is the base length R11. A pair of parallax images in the horizontal direction can be obtained by image capturing with use of the imaging units 96 and 97.

On the other hand, the length between the optical axes L1 and L4 is the base length R9. A pair of parallax images in the vertical direction of the camera main body 13 can be obtained by image capturing with use of the imaging units 11 and 97. In the same manner, the length between the optical axes L2 and L3 is the base length R9. A pair of parallax images in the vertical direction of the camera main body 13 can be obtained by image capturing with use of the imaging units 12 and 96.

The base length R11 is the shortest base length when the two imaging units in the horizontal orientation are arranged horizontally. In addition, the base length R9 is the shortest base length when the two imaging units in the horizontal orientation are arranged vertically. Accordingly, this arrangement of the imaging units is suitable for image capturing of a close landscape or subject.

As described above, since the four imaging units are attached to the camera main body 13, an appropriate base length for image capturing of a subject can be selected, and a pair of parallax images in the vertical direction can be obtained as well as a pair of parallax images in the horizontal direction.

As well known, the pair of parallax images in the horizontal direction can be used for composing a panoramic image, for composing a stereo image, for calculation of three-dimensional data of a subject, and so on. In addition, when the pair of parallax images in the vertical direction is used together for the calculation of the three-dimensional data, a feature point which is necessary for the calculation can be easily extracted. For example, a feature point of a horizontally long image such as the skyline is not easily extracted from a pair of parallax images in the horizontal direction. In this case, a pair of parallax images in the vertical direction is useful to extract the feature point.

In the above embodiments using the four imaging units, the optical axes are on lines along the vertical direction, as well as the horizontal direction, to obtain a pair of parallax images in the vertical direction. However, the four imaging units can be arranged such that two of them make a certain base length along the horizontal direction and other two make another base length along the horizontal direction.

For example, as shown in FIG. 21, the imaging units 11 and 12 in the horizontal orientation are attached to the camera main body 13, such that the optical axis L1 of the imaging unit 11 and the optical axis L2 of the imaging unit 12 are positioned farthest to each other. In addition, the imaging unit 96 below the imaging unit 12 and the imaging unit 97 below the imaging unit 11 both in the horizontal orientation are attached to the camera main body 13, such that the optical axis L3 of the imaging unit 96 and the optical axis L4 of the imaging unit 97 are closest to each other.

At this time, the length between the optical axes L1 and L2 is the base length R10. A pair of parallax images in the horizontal direction can be obtained by image capturing with use of the imaging units 11 and 12. The length between the optical axes L3 and L4 is the base length R11. A pair of images with parallax in the horizontal direction can be obtained by image capturing of a subject with use of the imaging units 96 and 97 at the same time.

On the other hand, the optical axes L1 and L4 are out of alignment both in the horizontal direction and the vertical direction. Accordingly, a pair of images captured by the imaging units 11 and 97 cannot simply be handled as parallax images in the long side or short side direction of the images. The same is true for a pair of images captured by the imaging units 12 and 96.

However, this arrangement of the four imaging units can obtain a pair of parallax images by the base length R10 in the horizontal direction and a pair of parallax images by the base length R11 in the horizontal direction at the same time. Accordingly, it is possible to capture images of a distant and a close subjects with appropriate base lengths, without changing the positions and orientations of the imaging units 11, 12, 96 and 97. That is, burdensomeness of changing the arrangement of the imaging unit is reduced.

In the above embodiments with use of the four imaging units, all of the imaging units are in the horizontal orientation. However, some of four imaging units may be in the vertical orientation when attached to the camera main body 13.

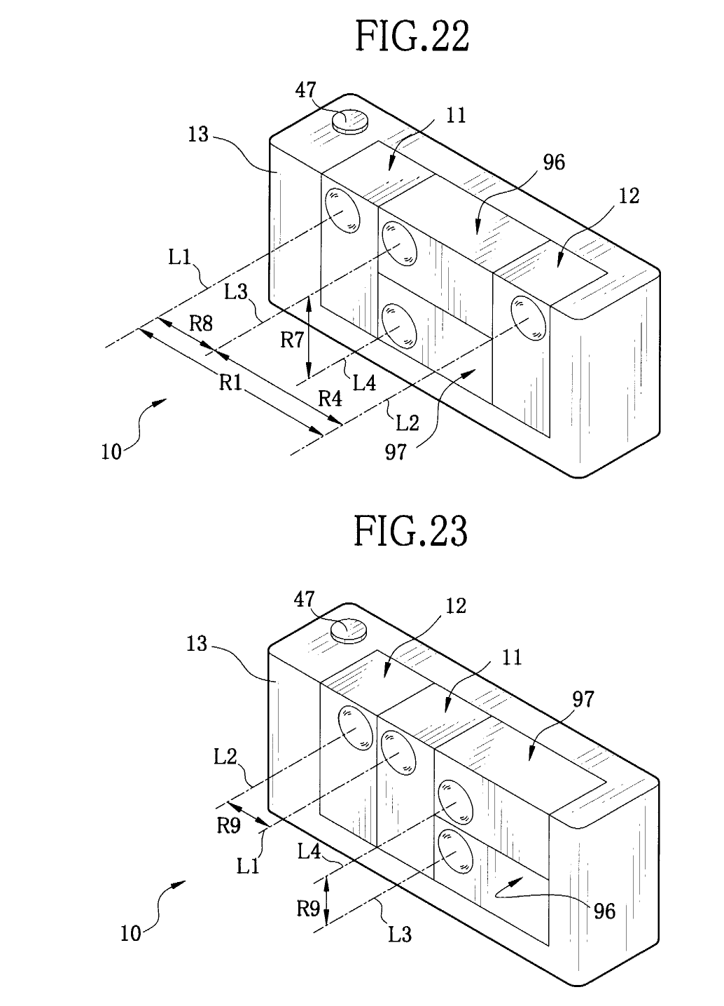

For example, as shown in FIG. 22, the imaging units 11 and 12 in the vertical orientation are attached to the camera main body 13, such that the optical axis L1 of the imaging unit 11 and the optical axis L2 of the imaging unit 12 are positioned farthest to each other. In addition, the imaging unit 96 and the imaging unit 97 below the imaging unit 96 both in the horizontal orientation are positioned between the imaging units 11 and 12, such that the optical axis L3 of the imaging unit 96 and the optical axis L4 of the imaging unit 97 are positioned farthest to each other in the vertical direction.

At this time, the length between the optical axes L1 and L2 is the base length R1. A pair of parallax images in the horizontal direction can be obtained by image capturing with use of the imaging units 11 and 12. The length between the optical axes L3 and L4 is the base length R7. A pair of parallax images in the vertical direction can be obtained by image capturing with use of the imaging units 96 and 97.

The base length R1 is the longest base length when the two imaging units in the vertical orientation are arranged horizontally. In addition, the base length R7 is the longest base length when the two imaging units in the horizontal orientation are arranged vertically. Accordingly, this arrangement of the imaging units is suitable for image capturing of a distant landscape or subject.

When Lp=Lq, the optical axes L1, L2, L3 are on the same level. At this time, the length between the optical axes L1 and L3 is the base length R8, and the length between the optical axes L2 and L3 is the base length R4. Accordingly, overlapped portions of the images captured by the imaging units 11 and 96 can be handled as a pair of parallax images in the horizontal direction. In the same manner, overlapped portions of the images captured by the imaging units 12 and 26 can be handled as a pair of parallax images in the horizontal direction.

For another example, as shown in FIG. 23, the imaging units 11, 12 in the vertical orientation are made adjacent on one side of the concave container portion 44 of the camera main body 13, such that the optical axis L1 of the imaging unit 11 and the optical axis L2 of the imaging unit 12 are positioned closest to each other. In addition, the imaging unit 97 and the imaging unit 96 below the imaging unit 97 both in the horizontal orientation are positioned on the other side of the concave container portion 44 of the camera main body 13, such that the optical axis L3 of the imaging unit 96 and the optical axis L4 of the imaging unit 97 are positioned closest to each other in the vertical direction.

At this time, the length between the optical axes L1 and L2 is the base length R9. A pair of parallax images in the horizontal direction can be obtained by image capturing with use of the imaging units 11 and 12. The length between the optical axes L3 and L4 is the base length R9. A pair of parallax images in the vertical direction can be obtained by image capturing with use of the imaging units 96 and 97.

The base length R9 is the shortest base length when the two imaging units in the vertical orientation are arranged horizontally. In addition, the base length R9 is the shortest base length when the two imaging units in the horizontal orientation are arranged vertically. Accordingly, this arrangement of the imaging units is suitable for image capturing of a close landscape or subject.

As described above, since in the multi-eye camera 10 of the present invention the imaging units with the bending optical system are detachably attached to the camera main body 13, the base length can be selected from the option according to the distance to a subject.

The above embodiments describe only a few of many variations in combinations and arrangements of the imaging units. The multi-eye camera 10 can be used with undescribed combinations and arrangements of the imaging units.

In the above embodiments, two or four imaging units are attached to the camera main body 13. However, three imaging units may be attached in any attachment positions and orientation to the camera main body 13. In addition, the multi-eye camera may be designed to contain five or more imaging units on the camera main body at the same time. When a number of attached imaging units is increased, the option of base lengths is also increased.

In the above embodiment, when four imaging units are used, there are the imaging units 11, 12, 96, 97. However, other combinations of four imaging units can be used. For example, the imaging unit 11 and three imaging units having the same construction as the imaging unit 11 can be used.

In the above embodiment, the imaging units and the camera main body 13 are electrically connected through the convex connectors 17a, 17b of each imaging unit and the concave connectors 46 of the camera main body 13. However, signal communication between the imaging unit and the camera main body 13 may be performed without wires. In addition, electric power may be fed from the camera main body 13 to the imaging units by electromagnetic induction or any other method.

The convex connector and the concave connector of the above embodiments are mere examples. That is, shapes, attachment positions, numbers and so on of these connectors are not limited. In addition, the detection method for attachment position and the orientation of the imaging unit is not limited to the above embodiments, but may be selected from common methods. For example, the camera main body 13 may receive detailed ID information from an imaging unit, when the imaging unit is attached to the camera main body 13, to recognize the construction and so on of the imaging unit. As another example, mechanical switches and the like may be provided to the camera main body 13 to detect the attachment position and the orientation of the imaging unit.

In the above embodiments, the imaging unit driving section 71 is provided in the camera main body 13. However, the imaging unit driving section 71 or a part of it may be provided in each imaging unit.

In the above embodiments, the display panel 49 is the liquid-crystal display with using the parallax barrier. However, any known display such as an organic EL display, an LED display, and a plasma display can be also used in the multi-eye camera 10. In addition, although the display panel with the parallax barrier is used for stereoscopic view of an image, a display panel with a lenticular lens may be used instead.

In the above embodiments, the orientation of the imaging unit is changed between the vertical orientation and the horizontal orientation. Accordingly, an imaging unit in which the CCD 32 rotates at ±90° with respect to the imaging unit according to change of the orientation may be used. In general, a right receiving surface of the CCD has a rectangular shape. Accordingly, when the imaging unit with the fixed CCD is rotated from the vertical orientation to the horizontal orientation, a shape of captured image is also changed from horizontally long to vertically long. On the other hand, when the imaging unit with the rotatable CCD is used, the orientation of the imaging unit can be changed without changing the orientation of the captured image.

In the above embodiments, there are two positions of the optical axis with respect to the front face of the imaging unit, one is the position of the optical axis L1 of the imaging unit 11 and the other is the position of the optical axis L2 of the imaging unit 12. However, other positions of the optical axis with respect to the front face of the imaging unit may be used in the present invention. In the above embodiments, the optical axis L1 of the imaging unit 11 and the optical axis L2 of the imaging unit 12 are symmetrical. However, the positional relation of the optical axes between the imaging units is not limited to above.

In the above embodiments, the imaging unit has the rectangular parallelepiped shape, and the rectangular front face of the imaging unit has the aspect ratio of 2:1. However, the shape of the imaging unit is not limited to above. For example, the rectangular front face of the imaging unit may have the aspect ratio of 3:1 or such. In addition, the imaging unit may have a cubic shape.

In the above embodiments, when less than four of the imaging units are attached in the concave container portion 44 of the camera main body 13, in the concave container portion 44 there becomes an empty space where the imaging unit is not attached. However, a spacer or the like having the same shape as the imaging unit may be attached in the empty space in the concave container portion 44. In addition, an additional functional unit such as a light-emitting unit with a flash lamp, which adds a function to the multi-eye camera, may be attached in the empty space.

In the above embodiments, the general functions of digital cameras, such as video recording, flash emission and shake correction are not explained. However, it is preferable to incorporate these general functions in the multi-eye camera of the present invention.

In the above embodiments, the prism 27 bends the subject light and leads it to the CCD 32. However, a mirror or the like may be used for bending the subject light and leading it to the CCD 32. In addition, when there is enough length in the depth direction of the multi-eye camera, the imaging unit can use a straight optical system instead of the bending optical system.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A multi-eye image pickup device having a plurality of pairs of an imaging optical system with an image pickup element, said plurality of pairs collecting and imaging light from a same subject at approximately same time to obtain a pair of images with parallax, said multi-eye image pickup device comprising:
a plurality of imaging units each of which has said imaging optical system and said image pickup element; and
a camera main body to which said imaging units are detachably attached with their attachment positions and orientations being selectable.

2. A multi-eye image pickup device claimed in claim 1, wherein said imaging optical system is a bending optical system which bends light from said subject toward said image pickup element.

3. A multi-eye image pickup device claimed in claim 2, said bending optical system including:
an objective lens from which subject light enters;
a prism which refracts said subject light from said objective lens toward said image pickup element;
a zoom lens positioned between said prism and said image pickup element, and movable along the optical axis direction to change imaging magnification;
an aperture stop provided below said zoom lens; and
a focus lens positioned between said aperture stop and said image pickup element, and movable along said optical axis direction for focus control.

4. A multi-eye image pickup device claimed in claim 3, said imaging unit further comprising an optical system driver for driving said bending optical system, said optical system driver including:
a zoom carriage which holds said zoom lens and is movable along said optical axis direction;
a zoom lead screw which is parallel to said optical axis direction and is threaded to a screw portion of said zoom carriage;
a zoom motor for rotating said zoom lead screw;
an aperture motor for changing size of an aperture opening of said aperture stop;
a focus carriage which holds said focus lens and is movable along said optical axis direction;
a focus lead screw which is parallel to said optical axis direction and is threaded to a screw portion of said focus carriage; and
a focus motor for rotating said focus lead screw.

5. A multi-eye image pickup device claimed in claim 1, wherein said imaging unit has a rectangular parallelepiped shape.

6. A multi-eye image pickup device claimed in claim 5, wherein an objective lens of said imaging optical system is positioned on a front face of said imaging unit, the center of said objective lens and the center of said front face being not coincident.

7. A multi-eye image pickup device claimed in claim 6, wherein said front face have a rectangular shape whose long side is twice as long as whose short side, said objective lens being positioned near to one of four corners of said front face.

8. A multi-eye image pickup device claimed in claim 7, wherein a distance between the center of said objective lens and said long side nearest to said objective lens is the same as a distance between the center of said objective lens and said short side nearest to said objective lens.

9. A multi-eye image pickup device claimed in claim 7, wherein a distance between the center of said objective lens and said long side nearest to said objective lens is different from a distance between the center of said objective lens and said short side nearest to said objective lens.

10. A multi-eye image pickup device claimed in claim 7, wherein said plurality of imaging units includes a first imaging unit and a second imaging unit, objective lenses of said first and second imaging units being symmetrically-positioned about contacting side faces of said first and second imaging units, when said first and second imaging units are arranged such that said side faces are in contact and said front faces are on a same line.

11. A multi-eye image pickup device claimed in claim 5, said camera main body including:
a concave container portion in which each of said imaging units can be contained in horizontal or vertical orientation; and
a unit controller which connects said imaging unit contained in said concave container portion to obtain image data from said imaging unit.

12. A multi-eye image pickup device claimed in claim 11, wherein said concave container portion has an attachment face of rectangular shape, each of short and long sides of said attachment face being natural-number times as long as each side of said imaging unit.

13. A multi-eye image pickup device claimed in claim 11, wherein said concave container portion can contain a plurality of pairs of said imaging units in horizontal orientation, said pairs being arranged in the vertical direction of said concave container portion.

14. A multi-eye image pickup device claimed in claim 11, wherein said concave container portion can contain at the same time a pair of said imaging units whose optical axes are arranged in the horizontal direction and another pair of said imaging units whose optical axes are arranged in the vertical direction.

15. A multi-eye image pickup device claimed in claim 12, wherein said imaging unit has a first connector on a face opposite to a face where an objective lens of said imaging optical system is positioned, and wherein said camera main body has a plurality of second connectors on said attachment face,
one of said second connectors being faced and connected to said first connector according to an attachment position and an orientation of said imaging unit, and said unit controller detecting said attachment position and said orientation of said imaging unit according to connection state between said first and second connectors.
